(19) United States
(12) Patent Application Publication
(10) Pub. No.: US 2026/0103295 A1
(43) Pub. Date: Apr. 16, 2026

(54) PROPELLANT VAPORIZATION REDUCTION LAUNCHER SYSTEM

(71) Applicant: Korea Aerospace Research Institute, Daejeon (KR)

(72) Inventors: Kwangkun Park, Daejeon (KR); Mansu Seo, Daejeon (KR); Seungwhan Baek, Daejeon (KR); I Sang Yu, Daejeon (KR); Inseok Yeo, Daejeon (KR); Yongwook Kim, Daejeon (KR)

(21) Appl. No.: 19/330,572

(22) Filed: Sep. 16, 2025

(30) Foreign Application Priority Data
Oct. 15, 2024 (KR) 10-2024-0139990
Jul. 9, 2025 (KR) 10-2025-0092181

(51) Int. Cl. B64G 1/00; F17C 5/02

(52) U.S. Cl. CPC B64G 1/002; F17C 5/02; F17C 2221/011; F17C 2221/033; F17C 2223/0161; F17C 2270/0197

(57) ABSTRACT

A propellant vaporization reduction launcher system supporting a vertically erected launch vehicle before launching and charging a propellant into the launch vehicle, the propellant vaporization reduction launcher system may include: a launcher supporting the launch vehicle; a fuel tank provided outside the launcher; a supply line charging the propellant stored in the fuel tank into a propellant tank of the launch vehicle through the launcher; and a spraying device installed in the launcher and spraying water mist onto an outer surface of the propellant tank into which the propellant is charged.

### CROSS-REFERENCE TO RELATED APPLICATIONS

This application claims priority under 35 U.S.C. § 119 to Korean Patent Application No. 10-2024-0139990, filed on Oct. 15, 2024, and Korean Patent Application No. 10-2025-0092181, filed on Jul. 9, 2025 with the Korean Intellectual Property Office, the disclosures of which are incorporated herein by reference in their entirety.

### TECHNICAL FIELD

The following disclosure relates to a launcher system capable of reducing vaporization of a cryogenic propellant during charging of a propellant into a launch vehicle.

### BACKGROUND

Launch vehicles using cryogenic propellants emit a large amount of propellant vaporization gas into the atmosphere during a charging process.

A launcher system should store a propellant in consideration of the propellant that is vaporized and discarded. As the amount of propellant discarded into the atmosphere increases, the cost of propellant increases.

In addition, with the recent introduction of launch vehicles using liquid methane as fuel, methane vaporized and emitted into the atmosphere during the charging of the fuel of methane-fueled launch vehicles may accelerate global warming.

### RELATED TECHNOLOGY DOCUMENT

(Patent Document 1) Korean Patent Laid-Open Publication No. 10-2024-0059937 (May 8, 2024)

The disclosure of this section is to provide background information relating to the invention. Applicant does not admit that any information contained in this section constitutes prior art.

### SUMMARY

An embodiment of the present disclosure is directed to providing a launcher system capable of reducing vaporization of a cryogenic propellant inside a propellant tank and reducing vaporization gas during a charging process of a launch vehicle by spraying a water mist around the propellant tank to promote a generation of frost on a surface of the propellant tank.

In one general aspect, a propellant vaporization reduction launcher system supporting a vertically erected launch vehicle before launching and charging a propellant into the launch vehicle, the propellant vaporization reduction launcher system includes: a launcher supporting the launch vehicle; a fuel tank provided outside the launcher; a supply line charging the propellant stored in the fuel tank into a propellant tank of the launch vehicle through the launcher; and a spraying device installed in the launcher and spraying water mist onto an outer surface of the propellant tank into which the propellant is charged.

The propellant may be liquid methane or liquid oxygen.

The spraying device may be provided corresponding to a supply line and disposed on an upper portion of the propellant tank.

The spraying device may include: a support having one end installed in the launcher; and a spraying unit installed on the other end of the support and spraying water mist.

The spraying unit may have a plurality of spraying nozzles provided at a lower portion thereof and spray the water mist downward.

The spraying unit may be rotatably connected to the other end of the support by a hinge.

The spraying unit may be provided in a pair in an arc shape so as to surround a circumference of the propellant tank.

The spraying unit may be provided with a shielding film that spreads downward and covers the propellant tank.

The support may be provided with a humidity measuring sensor that measures humidity around the propellant tank.

The amount of water mist sprayed by the spraying unit may be controlled according to the humidity around the propellant tank measured by the humidity measuring sensor.

### BRIEF DESCRIPTION OF THE DRAWINGS

FIG. 1 is a diagram illustrating vaporization of a propellant in a launcher system.

FIG. 2 is a diagram illustrating a propellant vaporization reduction launcher system according to the present disclosure.

FIG. 3 is an enlarged view of a spraying device in FIG. 2.

FIGS. 4 and 5 are views illustrating FIG. 2 as seen from above.

FIG. 6 is a diagram illustrating a shielding film added to FIG. 2.

### DETAILED DESCRIPTION OF MAIN ELEMENTS

10: Launch vehicle
11: Propellant tank
110: Launcher
120: Supply line
130: Spraying device
131: Spraying unit
1311: Spraying nozzle
132: Support
133: Hinge
140: Fuel tank
141: Propellant
150: Shielding film

### DETAILED DESCRIPTION OF EMBODIMENTS

Hereinafter, the present disclosure will be described in detail with reference to the accompanying drawings. However, this is merely an example and the present disclosure is not limited to the specific embodiments described herein by way of example.

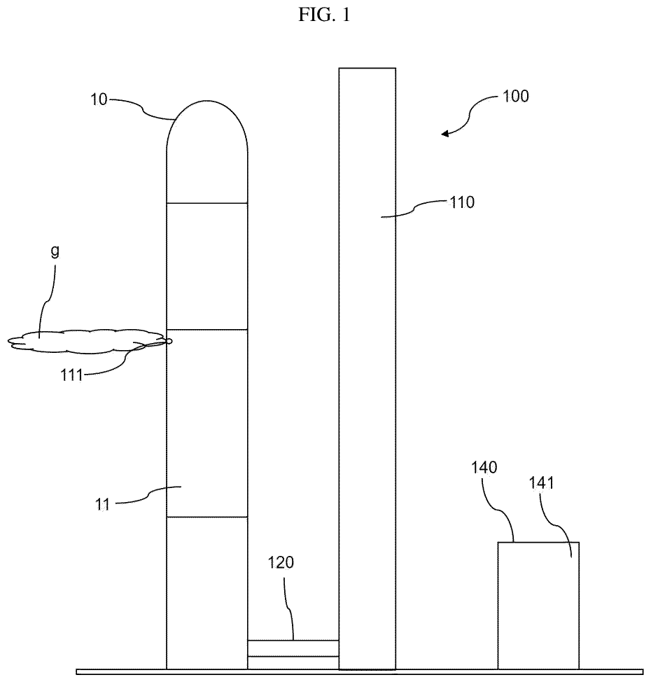

Referring to FIG. 1, a launch vehicle 10 is vertically erected in a launcher system before launching, and propellant 141 is charged into the propellant tank 11 configured in the launch vehicle 10. A plurality of propellant tanks 11 may be separately provided in the launch vehicle 10.

In the case of using a cryogenic liquid as the propellant 141, in order to prevent the pressure inside the propellant tank 11 from increasing due to the propellant 141 vaporized inside the propellant tank 11 during charging of the cryogenic liquid into the propellant tank 11 and at the same time as the charging, a propellant vaporization gas g vaporized is discharged through a hole 111 formed on an upper portion of the propellant tank 11. The hole 111 is closed when the charging of the propellant tank 11 is completed.

The propellant vaporization gas g generated during the charging is continuously generated during the charging process, so the propellant vaporization gas g discarded causes a lot of waste of propellant 141. When the liquid methane is used as the propellant 141, it causes environmental problems of global warming.

A propellant vaporization reduction launcher system 100 according to an embodiment of the present disclosure may reduce the vaporization amount of propellant 141 inside the propellant tank 11 by promoting the generation of frost attached to a surface of the propellant tank 11 during the charging process of the propellant 141.

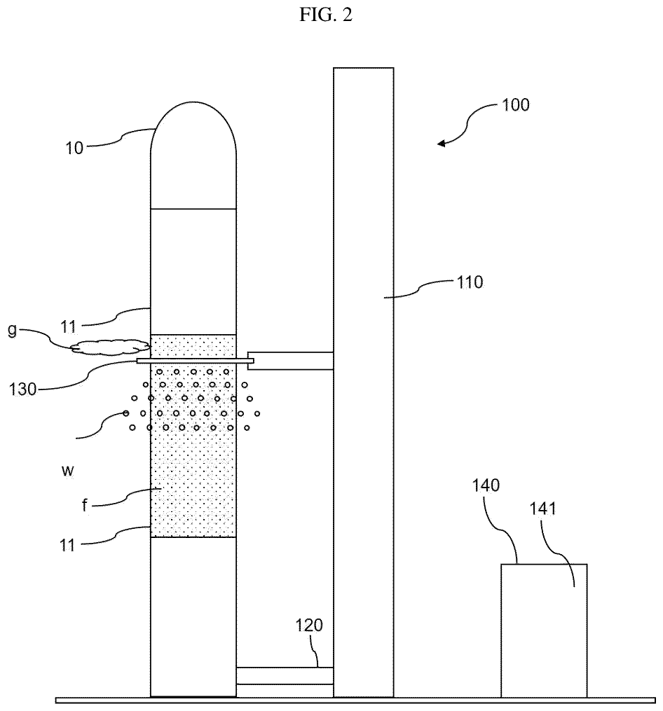

Referring to FIG. 2, the propellant vaporization reduction launcher system 100 according to an embodiment of the present disclosure may be configured to include a launcher 110, a fuel tank 140, a supply line 120, and a spraying device 130.

The launcher system 100 supports a vertically erected launch vehicle 10 before launching and charges the propellant 141 into the launch vehicle 10.

The launcher 110 supports the launch vehicle 10.

The fuel tank 140 is provided outside the launcher 110 to store the propellant 141.

The supply line 120 may charge the propellant 141 stored in the fuel tank 140 into the propellant tank 11 of the launch vehicle 10 through the launcher 110.

The supply line 120 is connected to the fuel tank 140 to supply the propellant 141 to the launch vehicle 10, and is installed in the launcher 110 and connected to the launch vehicle 10 to charge the propellant 141 into the propellant tank 11. Here, the propellant 141 may use cryogenic liquid methane or liquid oxygen.

The spraying device 130 is installed in the launcher 110 and may spray water mist onto an outer surface of the propellant tank 11 into which the propellant 141 is charged.

In the launch vehicle 10, the propellant tank 11 may be configured to be divided into multiple units, and the supply line 120 may be configured to correspond to the propellant tank 11. The spraying device 130 may also be provided to correspond to the supply line 120.

Referring to FIG. 2, the propellant tank 11 may be seen to be provided in two units in the launch vehicle 10. The propellant tank 11 is configured vertically with a constant length, and the supply line 120 may be connected to each propellant tank 11. In response to this, the spraying device 130 may also be provided to correspond to each propellant tank 11.

The spraying device 130 may be disposed on the upper portion of the propellant tank 11.

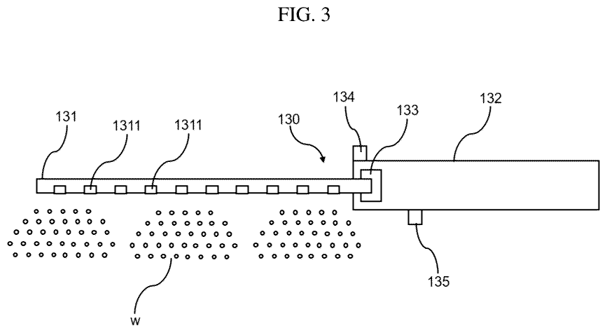

Referring to FIG. 3, the spraying device 130 may include a support 132 of which the one end is installed in the launcher 110, and a spraying unit 131 installed at the other end of the support 132 to spray water mist w.

The spraying unit 131 has a plurality of spraying nozzles 1311 provided on the lower portion thereof to spray the water mist w downward. The spraying nozzle 1311 may spray the water mist w radially downward, and as a result, moisture may condense on the surface of the propellant tank 11 to generate frost.

The water mist w is sprayed with the spraying nozzle 1311 of the spraying unit 131, so the frost may be generated quickly on the entire surface of the propellant tank 11. This may promote the generation of frost on the surface of the propellant tank 11 and generate an insulation effect that reduces the transfer of heat in the atmosphere into the inside of the propellant tank 11. As illustrated in FIG. 2, the vaporization of the cryogenic propellant 141 inside the propellant tank 11 may be reduced due to the insulation effect.

The support 132 may be provided with a humidity measuring sensor 134 that measures humidity around the propellant tank 11. The amount of water mist w sprayed by the spraying unit 131 may be controlled according to the humidity around the propellant tank 11 measured by the humidity measuring sensor 134.

Before spraying the water mist w from the spraying unit 131, the humidity measuring sensor 134 may measure the humidity around the propellant tank 11. The amount of water mist w sprayed by the spraying unit 131 may be controlled according to the measured humidity around the propellant tank 11. When the humidity around the propellant tank 11 is high, the amount of water mist w sprayed by the spraying unit 131 may be reduced, and when the humidity around the propellant tank 11 is low, the amount of water mist w sprayed by the spraying unit 131 may increase.

This allows frost to be quickly generated over the entire surface of the propellant tank 11, and allows frost of a constant thickness to be generated on the surface of the propellant tank 11 regardless of the surrounding environment such as the humidity.

In addition, the support 132 may be provided with a thickness measuring sensor 135 that measures the thickness of the frost formed on the surface of the propellant tank 11.

The thickness measuring sensor 135 may be configured with an ultrasonic sensor, etc., and may measure the thickness of the frost generated on the surface of the propellant tank 11. The thickness may be measured by comparing the difference in thickness before and after the generation of the frost. By measuring the thickness of the frost formed on the surface of the propellant tank 11, the amount of water mist w sprayed by the spraying unit 131 may be controlled.

In addition, as described above, the control of the humidity measuring sensor 134, the thickness measuring sensor 135, and the spraying unit 131 may be performed by a control device installed in the launcher 110. In addition, the control device installed in the launcher 110 may perform control over the overall device.

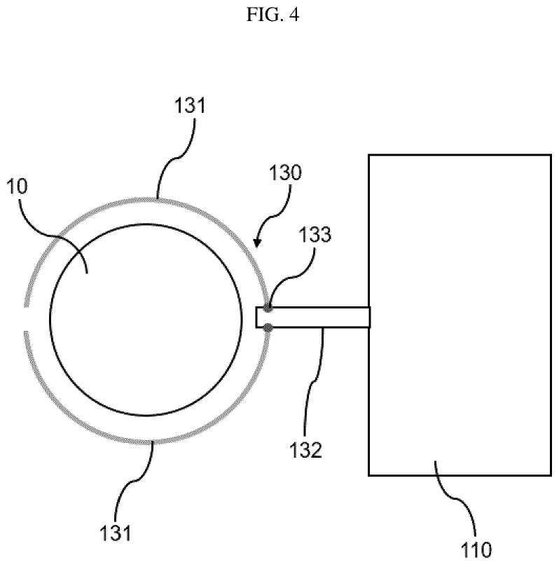

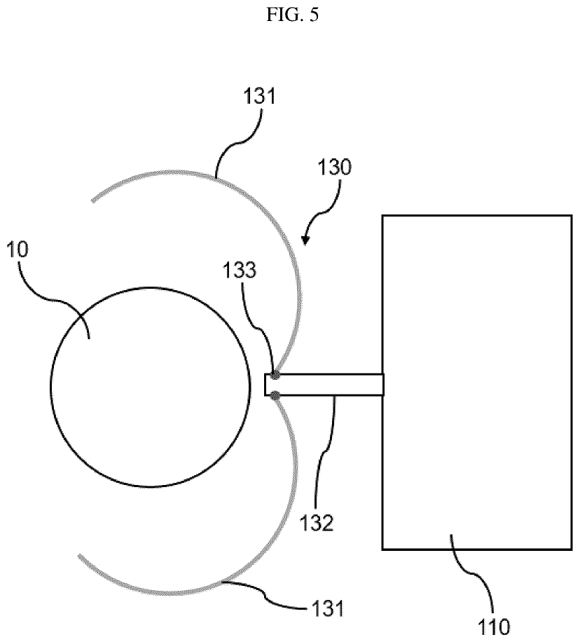

Referring to FIGS. 4 and 5, the spraying unit 131 may be rotatably connected to the other end of the support 132 by a hinge 133. The support 132 may have one end installed on the launcher 110 and the other end thereof may be provided with the spraying unit 131.

The spraying unit 131 may be connected to the support 132 by the hinge 133 and may rotate in a direction closer to or further away from the launch vehicle 10.

The spraying unit 131 may be provided in a pair in an arc shape so that the spraying unit 131 may wrap around a circumference of the propellant tank 11.

The spraying unit 131 has the arc shape and is installed, and concave parts of the spraying unit 131 face each other so that the spraying unit 131 may wrap around the launch vehicle 10. By configuring the spraying unit 131 in the arc shape, the water mist w sprayed from the spraying nozzle 1311 may cover the entire circumference of the cylindrical launch vehicle 10.

It may be seen through FIG. 4 that the spraying unit 131 surrounds the launch vehicle 10, and when the charging of the propellant 141 is completed, the spraying unit 131 may be moved away from the launch vehicle 10 through rotation as illustrated in FIG. 5.

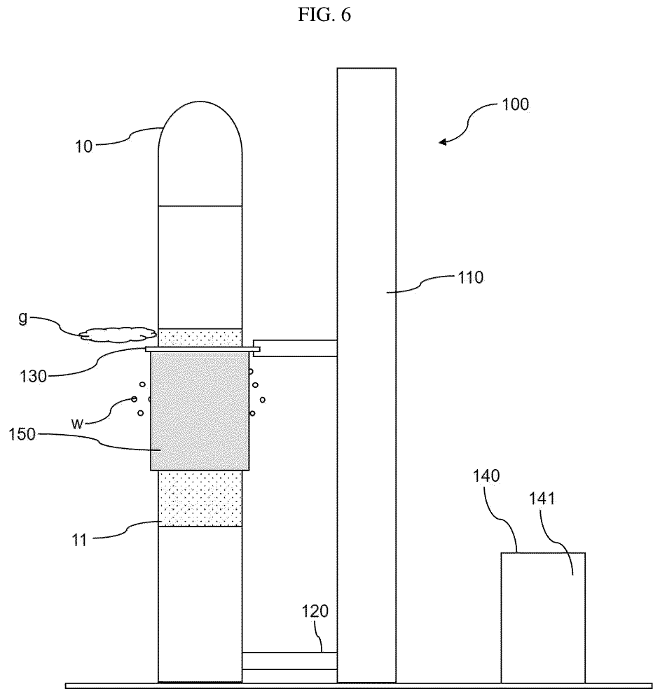

Referring to FIG. 6, a shielding film 150 that is spread downward and covers the propellant tank 11 may be installed in the spraying unit 131. The shielding film 150 may block solar radiation by covering the outside of the launch vehicle 10 like a curtain.

In addition, a frame like a fan rib may be installed in the shielding film 150 so that the frame does not flutter in the wind.

In this way, the propellant vaporization reduction launcher system 100 may minimize the influence of atmospheric temperature and humidity on the frost generated on the surface of the launch vehicle, thereby make the generation of frost constant.

As a result, the vaporization of the propellant may be reduced, which helps lower the propellant costs. In the case of using the liquid methane as the propellant, it is possible to reduce the atmospheric methane emissions and mitigate the greenhouse effect.

According to the present disclosure, it is possible to reduce the propellant vaporization by increasing the insulation effect of the launch vehicle tank.

The embodiments of the present disclosure described above are examples, and it will be apparent to those of ordinary skill in the art to which the present disclosure pertains that various modifications and equivalent other embodiments can be made therefrom. Therefore, it may be understood well that the present disclosure is not limited to only a form mentioned in the above detailed description. Accordingly, an actual technical scope of the present disclosure is to be defined by a technical spirit of the following claims. In addition, it is to be understood that the present disclosure includes all modifications, equivalents, and substitutes that fall in the spirit and scope of the present disclosure defined by the claims.

What is claimed is:

1. A propellant vaporization reduction launcher system supporting a vertically erected launch vehicle before launching and charging a propellant into the launch vehicle, the propellant vaporization reduction launcher system comprising:
a launcher supporting the launch vehicle;
a fuel tank provided outside the launcher;
a supply line charging the propellant stored in the fuel tank into a propellant tank of the launch vehicle through the launcher; and
a spraying device installed in the launcher and spraying water mist onto an outer surface of the propellant tank into which the propellant is charged.

2. The propellant vaporization reduction launcher system of claim 1, wherein the propellant is liquid methane or liquid oxygen.

3. The propellant vaporization reduction launcher system of claim 1, wherein the spraying device is provided corresponding to a supply line and disposed on an upper portion of the propellant tank.

4. The propellant vaporization reduction launcher system of claim 1, wherein the spraying device includes:
a support having one end installed in the launcher; and
a spraying unit installed on the other end of the support and spraying water mist.

5. The propellant vaporization reduction launcher system of claim 4, wherein the spraying unit has a plurality of spraying nozzles provided at a lower portion thereof and sprays the water mist downward.

6. The propellant vaporization reduction launcher system of claim 4, wherein the spraying unit is rotatably connected to the other end of the support by a hinge.

7. The propellant vaporization reduction launcher system of claim 6, wherein the spraying unit is provided in a pair in an arc shape so as to surround a circumference of the propellant tank.

8. The propellant vaporization reduction launcher system of claim 4, wherein the spraying unit is provided with a shielding film that spreads downward and covers the propellant tank.

9. The propellant vaporization reduction launcher system of claim 4, wherein the support is provided with a humidity measuring sensor that measures humidity around the propellant tank.

10. The propellant vaporization reduction launcher system of claim 9, wherein the amount of water mist sprayed by the spraying unit is controlled according to the humidity around the propellant tank measured by the humidity measuring sensor.
